(19) United States
(12) Patent Application Publication
(10) Pub. No.: US 2017/0099807 A1
(43) Pub. Date: Apr. 13, 2017

(54) PET VEST

(71) Applicant: Doskocil Manufacturing Company, Inc., Arlington, TX (US)

(72) Inventors: Melaney NORTHROP, Mansfield, TX (US); Linh HUYNH, Arlington, TX (US)

(21) Appl. No.: 14/951,994

(22) Filed: Nov. 25, 2015

Related U.S. Application Data
(60) Provisional application No. 62/238,742, filed on Oct. 8, 2015.

(51) Int. Cl. A01K 13/00

(52) U.S. Cl. CPC A01K 13/006

(57) ABSTRACT

A pet vest is basically provided with an upper portion, an underside portion and a collar portion. The upper portion is sized and structured to cover a pet dorsal area. The upper portion has a pocket configured to contain a calming device. The underside portion is sized and structured to cover a pet ventral area. The collar portion is disposed between proximal ends of the upper portion and the underside portion. The collar portion connects the upper portion and the underside portion. The collar portion defines a receiving hole sized and structured to substantially surround a pet neck area.

### BACKGROUND

Field of the Invention

This invention generally relates to a pet vest. More specifically, the present invention relates to a pet vest having a pocket configured to contain a calming device.

Background Information

Generally, some animals experience anxiety due to environmental factors such as loud noises during thunderstorms, fireworks or music playing. Animals are also known to experience anxiety during certain social situations such as meeting new people, new animals, crowds, children or having been introduced to an unknown environment. Animals and pets can be treated with certain calming therapies delivered via portable calming devices. These calming devices can be fixed to the animal via a wearable member such as a pet vest.

### SUMMARY

Generally, the present disclosure is directed to various features of a pet vest. In one feature, a pet vest is provided having an upper portion, an underside portion, a collar portion connecting the upper and underside portions and a pocket configured to contain a calming device.

In view of the state of the known technology and in accordance with a first aspect of the present disclosure, a pet vest is provided that basically comprises an upper portion, an underside portion and a collar portion. The upper portion is sized and structured to cover a pet dorsal area. The upper portion has a pocket configured to contain a calming device. The underside portion is sized and structured to cover a pet ventral area. The collar portion is disposed between proximal ends of the upper portion and the underside portion. The collar portion connects the upper portion and the underside portion. The collar portion defines a receiving hole sized and structured to substantially surround a pet neck area.

Other objects, features, aspects and advantages of the disclosed pet vest will become apparent to those skilled in the art from the following detailed description, which, taken in conjunction with the annexed drawings, discloses one embodiment of the pet vest.

### BRIEF DESCRIPTION OF THE DRAWINGS

Referring now to the attached drawings which form a part of this original disclosure:

FIG. 1 is a perspective view of a pet wearing a pet vest in accordance with one illustrated embodiment;

FIG. 2 is a front elevational view of the pet wearing the pet vest of FIG. 1;

FIG. 3 is an underside plan view of the front of the pet vest in FIGS. 1 and 2;

FIG. 4 is a backside elevational view of the pet wearing the pet vest of FIGS. 1 to 3;

FIG. 5 is an upper side plan view of the back of the pet vest of FIGS. 1 to 4;

FIG. 6 is a plan view of the outside layer of the pet vest of FIGS. 1 to 5 with the pet vest laid out flat and fastened;

FIG. 7 is a plan view of the inside layer of the pet vest of FIGS. 1 to 6 with the pet vest laid out flat and fastened;

FIG. 8 is an enlarged plan view of the outside layer of the pet vest of FIGS. 1 to 7 to show the outside layer of the pocket;

FIG. 9 is an enlarged plan view of the inside layer of the pet vest of FIGS. 1 to 8 to show the inside layer of the pocket;

FIG. 10 is an enlarged perspective view of the upper portion of the pet vest of FIGS. 1 to 9, showing the pocket opened.

FIG. 11 is a plan view of a pattern for the pet vest of FIGS. 1 to 10 having a first size;

FIG. 12 is a plan view of a pattern for the pet vest of FIGS. 1 to 10 having a second size;

FIG. 13 is a plan view of a pattern for the pet vest of FIGS. 1 to 10 having a third size;

FIG. 14 is a plan view of a pattern for the pet vest of FIGS. 1 to 10 having a fourth size;

FIG. 15 is a plan view of a pattern for the pet vest of FIGS. 1 to 10 having a fifth size; and

FIG. 16 is a plan view of a pattern for the pet vest of FIGS. 1 to 10 having a sixth size.

### DETAILED DESCRIPTION OF EMBODIMENTS

Selected embodiments will now be explained with reference to the drawings. It will be apparent to those skilled in the pet products field from this disclosure that the following descriptions of the embodiments are provided for illustration only and not for the purpose of limiting the invention as defined by the appended claims and their equivalents.

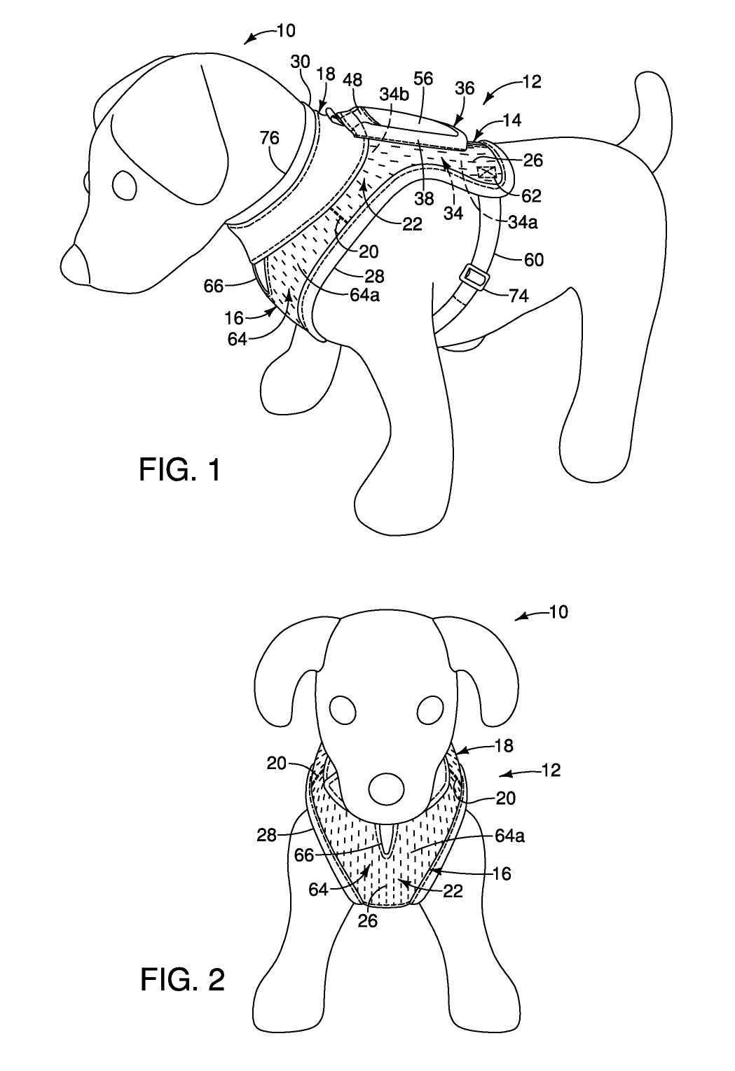

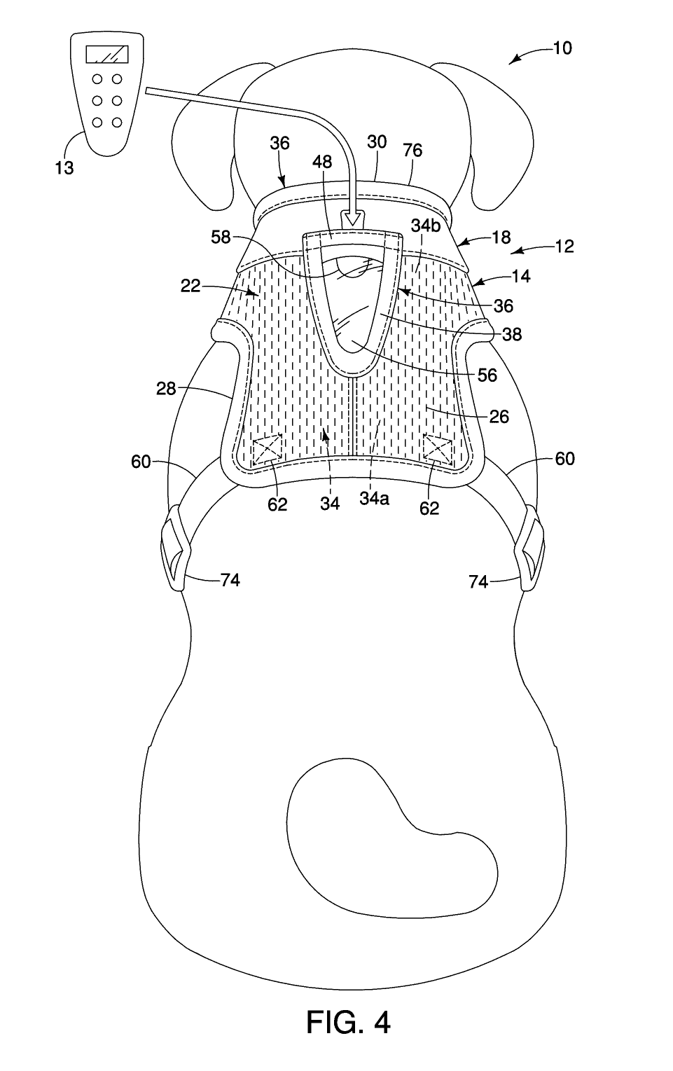

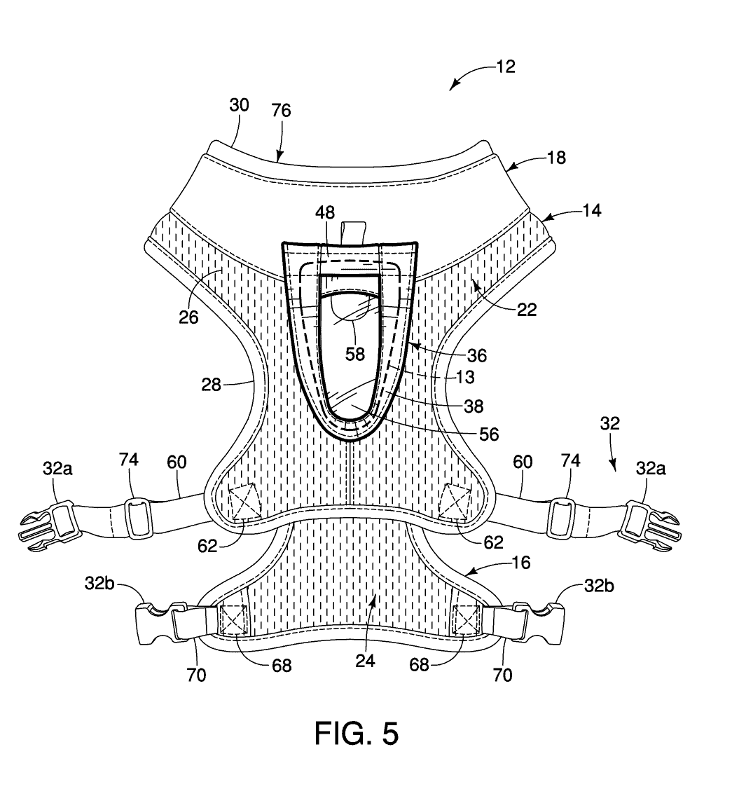

Referring initially to FIG. 1, a pet 10 is illustrated wearing a pet vest 12 in accordance with a first illustrated embodiment. The pet vest 12 is configured to contain a calming device 13 for the pet 10 (FIGS. 4 and 5). In the illustrated embodiment, the calming device 13 is configured to deliver non-invasive external therapies to the pet 10 to help calm the pet 10 during incidences of distress. Examples of non-invasive therapies include, but are not limited to, therapies delivered via modulated tones, varying degrees and styles of vibration, as well as light and smell. The pet vest 12 is configured to contain the calming device 13 and is designed as a wearable member for the pet 10 to deliver non-invasive external therapies to the pet 10.

In one embodiment, the calming device 13 is an electronic device that delivers calming therapy such as vibration and/or sound to a pet within the vicinity of the pet's upper back. One example of such a device is the CALMZ™ device. Alternatively, the calming device 13 can be an aroma therapy device or similar therapeutic device. In one embodiment, the calming device delivers sound and/or vibration to the pet in the form of music and/or a predetermined vibrational tone.

In the illustrated embodiment, the pet vest 12 is configured as a one-piece member from several constituent parts fixed to each other. In particular, the pet vest 12 comprises an upper portion 14, an underside portion 16 and a collar portion 18. Preferably, each of the upper portion 14, the underside portion 16 and the collar portion 18 are connected to each other at a plurality of connected sections 20. In the illustrated embodiment, the connected sections 20 are seams. Thus, the upper, underside and collar portions 14, 16 and 18 of the pet vest 12 are sewed together so that the pet vest 12 is a one-piece member. Preferably, the pet vest 12 is constructed primarily of a stretchable fabric to enable a snug fit on the pet 10, such as athletic mesh made of approximately 85% nylon and 15% spandex. It will be apparent to those skilled in the art from this disclosure that the pet vest 12 can be constructed of other materials or fabrics, as needed and/or desired.

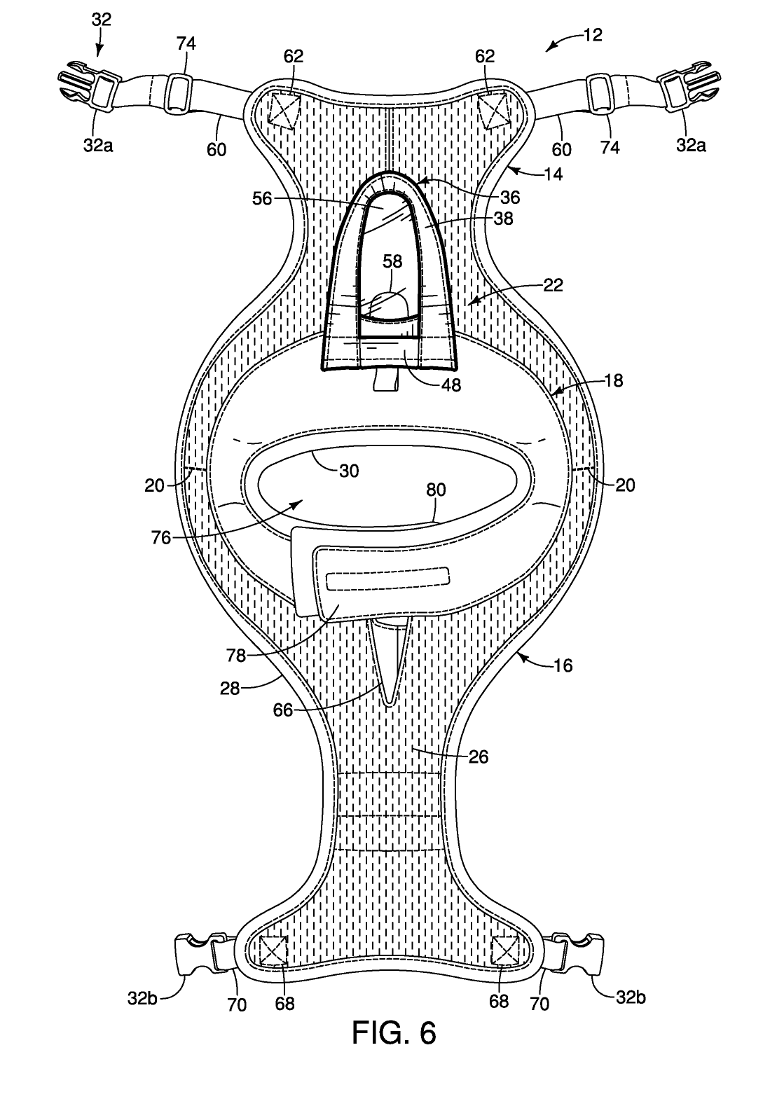

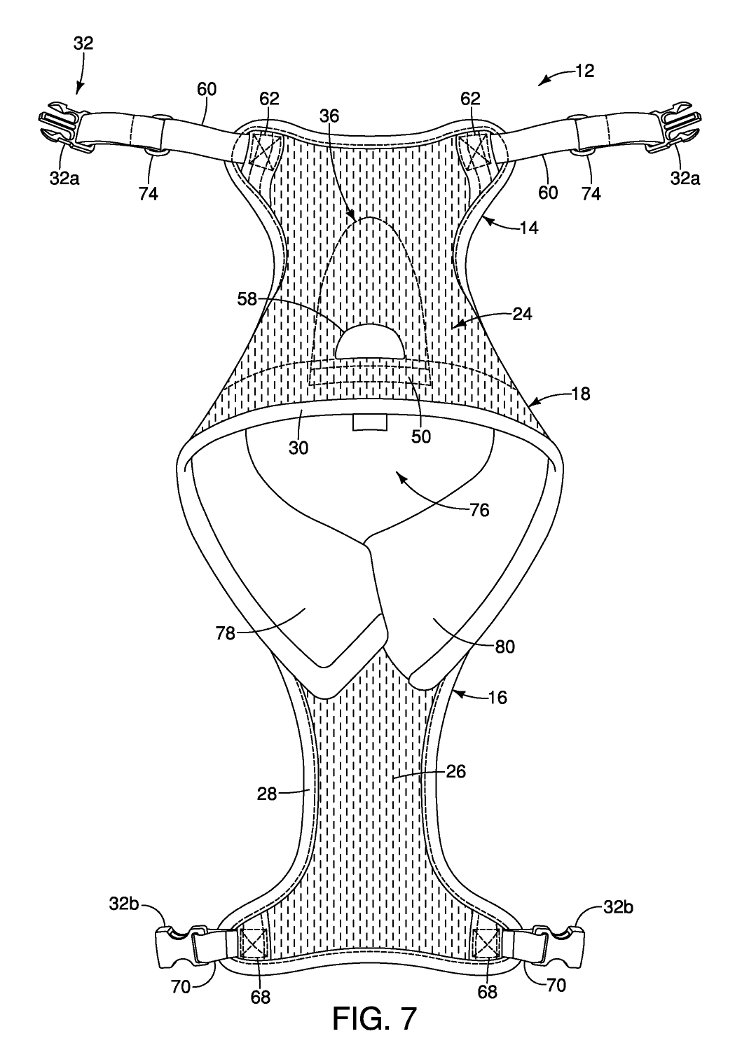

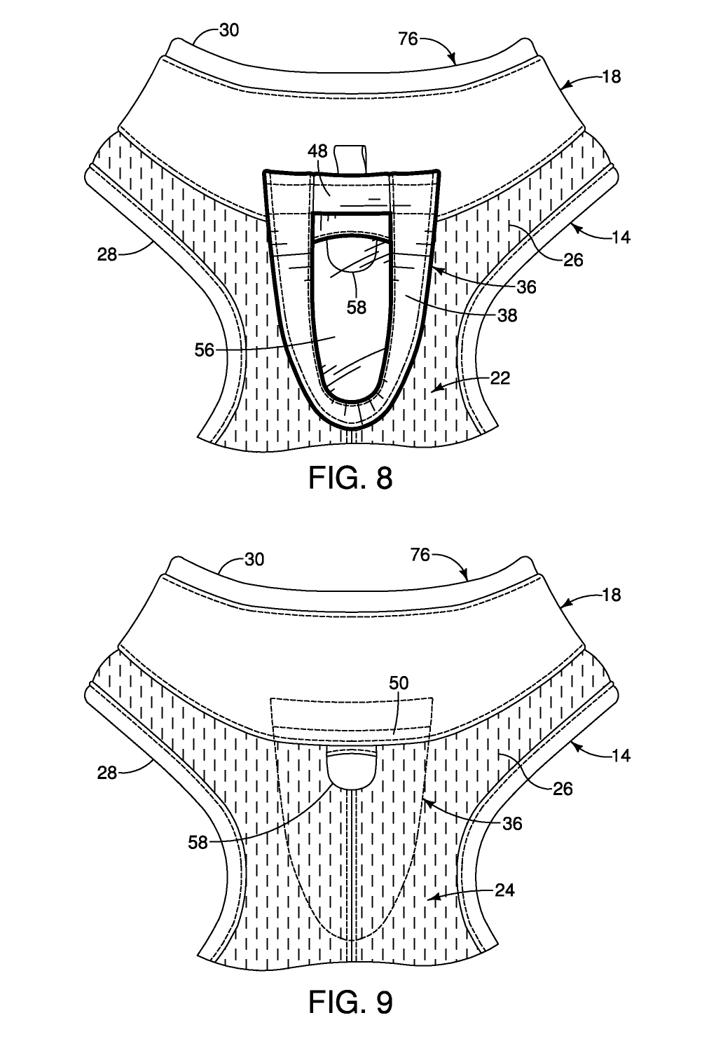

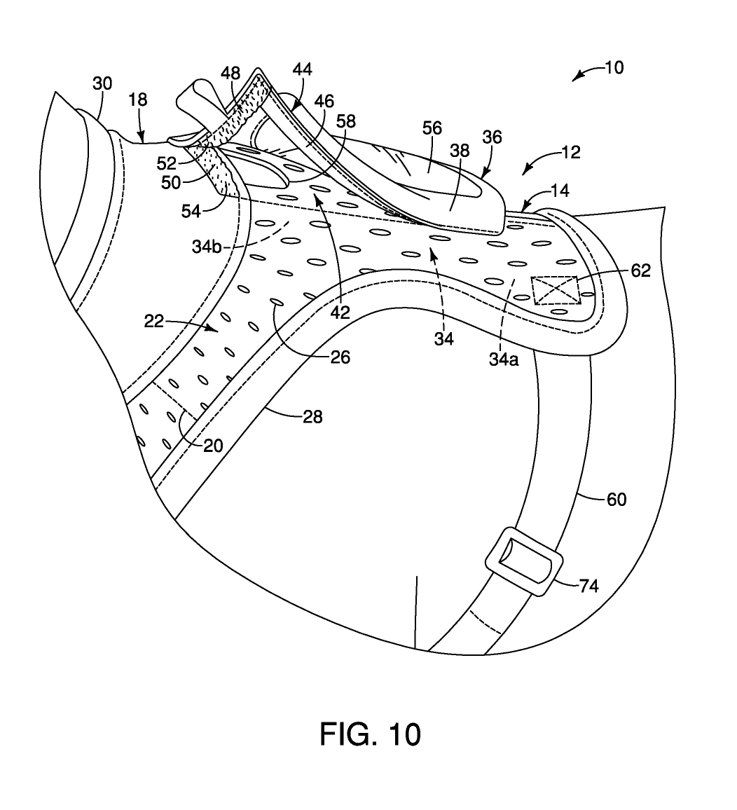

Referring now to FIGS. 1 to 10, in the illustrated embodiment, the upper, underside and collar portions 14, 16 and 18 of the pet vest 12 include an inner layer 22 (FIGS. 7 and 9) and an outer layer 24 (FIGS. 6 and 8). The inner and outer layers 22 and 24 can be constructed of the above mentioned stretchable fabric to include a plurality of slits 26 for ventilation. Also in the illustrated embodiment, parts of the pet vest 12 are preferably padded by including a thin foam layer (not shown) disposed between the inner layer 22 and the outer layer 24. In the illustrated embodiment, the foam layer is preferably ⅛ inch thick. The foam layer is not as stretchable as the inner and outer layers 22 and 24. The foam layer helps ventilation and allows the pet vest 12 to be more comfortable for wear. The foam layer also helps prevent the pet vest 12 from bunching and folding during wear. In the illustrated embodiment, the outer edges of the upper portion 14 and the underside portion 16 include a padded lining 28. The collar portion 18 also includes a lining 30 for an upper region of the collar that is preferably not padded. In the illustrated embodiment, the underside portion 16 and lining 28 include the foam layer but the upper portion 14 does not. It will be apparent to those skilled in the art from this disclosure that the upper, underside and collar portions 14, 16 and 18 can be structured to include lining, trim and/or padding at a variety of sections as needed or desired.

As best seen in FIGS. 5 to 7, the upper portion 14 and the underside portion 16 are secured to the pet 10 by a plurality of fastening members 32, as well as the collar portion 18. The upper portion 14 and the underside portion 16 are also directly sewn together at the connected sections 20 located preferably adjacent the collar portion 18, as shown. Preferably, the upper portion 14, the underside portion 16 and the collar portion 18 are secured together such that the pet vest 12 is substantially flat and there is very little bunching or folding when worn by the pet 10. The fastening members 32 are configured to be adjustable to enable a snug fit of the pet vest 12 on the pet 10 during wear.

The upper portion 14 of the pet vest 12 will now be discussed. As best seen in FIGS. 1 and 4, the upper portion 14 is sized and structured to cover a pet 10 dorsal area 34. The upper portion 14 has a pocket 36 configured to contain the calming device 13. In the illustrated embodiment, the pocket 36 is designed to contain the calming device 13 that is configured to deliver therapy directly to the pet dorsal area 34. Thus, the upper portion 14 is designed such that the pocket 36 overlies the pet dorsal area 34 when the pet vest 12 is worn by the pet 10. The dorsal area 34 includes a pet back area 34a and a pet neck area 34b. In the illustrated embodiment, the upper portion 14 overlies the pet neck area 34b and at least a region of the pet back area 34a when the pet vest 12 is worn by the pet 10. Preferably, the pocket 36 is positioned over both the pet neck area 34b and the pet back area 34a when the pet vest 12 is worn by the pet 10. It will be apparent to those skilled in the art from this disclosure that the pet vest 12 can be configured such that the pocket 36 is positioned over other areas of the pet's 10 body so that the calming device 13 can deliver therapies to different regions of the pet's 10 body as desired.

The pocket 36 is defined by an outer pocket layer 38 fastened over a part of the upper portion 14 and a part of the collar portion 18. As best seen in FIGS. 4 to 6 and 10, in the illustrated embodiment, the pocket 36 extends from the upper portion 14 of the vest into the collar portion 18. In the illustrated embodiment, the outer pocket layer 38 is sewn onto the upper portion 14 and the collar portion 18. It will be apparent to those skilled in the art from this disclosure that the pocket 36 can be attached to the upper and collar portions 14 and 18 via a variety of other techniques as needed and/or desired. For example, attachment techniques can be used so that the pocket 36 is detachably connectable to the upper portion 14, such as buttons, clasps, zipper or hook and loop fasteners. As shown in FIG. 10, the pocket layer 38 and the outer layer 24 of the upper portion 14 define an inside region 42 of the pocket 36. The inside region 42 of the pocket 36 receives and contains the calming device 13.

Preferably, the pocket 36 includes an openable side 44 to receive and remove the calming device 13 from the inside region 42 of the pocket 36. In the illustrated embodiment as shown, the openable side 44 extends from an upper section 48 of the pocket 36 to include an unsewn side portion 46 of the pocket 36. The upper section 48 of the pocket 36 has a first attachment layer 52 that is configured to overly an upper section 50 of the collar portion 18. The upper section 50 of the collar portion 18 has a second attachment layer 54 configured to engage the first attachment layer 52 to secure the calming device 13 in the inside region 42 of the pocket 36. In the illustrated embodiment as shown, the first and second attachment layers 52 and 54 are hook and loop fasteners. It will be apparent to those skilled in the art from this disclosure that the first and second attachment layers 52 and 54 can be other attachment means, such as zippers or buttons, as desired.

As best seen in FIGS. 5 and 6, the pocket 36 includes a transparent window 56 disposed on an outer region of the pocket 36. Specifically, the transparent window 56 is connected to the outer pocket layer 38, such as by sewing. In the illustrated embodiment, the transparent window 56 is a vinyl member. The window 56 enables the owner to see the calming device 13 while it is disposed in the inside region 42 of the pocket 36. In particular, the window 56 enables the pet owner to see indicators that are located on the calming device 13. As best seen in FIGS. 6 to 10, the pocket 36 includes a calming device protrusion opening 58 on the inside region 42 of the pocket 36. Specifically, the protrusion opening 58 is disposed in a region of the upper portion 14 that is covered by the outer pocket layer 38. The calming device protrusion opening 58 is sized and structured to receive a portion of the calming device 13 therethrough to enable direct contact of the pet 10 with the calming device 13. In this manner, the calming device protrusion opening 58 enables direct contact of at least one of the pet neck area 34b and the pet back area 34a when the pet vest 12 is worn by the pet 10.

Specifically, the protrusion opening 58 is structured to coincide with a calming device vibrational speaker or a transmitter (not shown) that delivers therapy for the pet 10 preferably via direct contact with the calming device 13. Therefore, the protrusion opening 58 defines a therapy delivery portion of the pet vest 12. Preferably, the protrusion opening 58 has a reinforced perimeter that has a thicker lining (not shown). In the illustrated embodiment as shown, the protrusion opening 58 is cut in the shape of a semi-circle that is 1-⅛ inches by ⅞ inches. It will be apparent to those skilled in the art that the protrusion opening 58 can have a variety of sizes and shapes to accommodate vibrational speakers of varying sizes.

As previously stated, the upper portion 14 and the underside portion 16 of the pet vest 12 are secured together, and to the pet 10, by the plurality of fastening members 32. As seen in FIGS. 3 to 7, the distal end of the upper portion 14 includes at least one first fastening member 32a so that the upper portion 14 is detachably connectable to the distal end of the underside portion 16. Preferably, the upper portion 14 includes a pair of first fastening members 32a. As shown, the first fastening members 32a are disposed at laterally opposite sides of the distal end of the upper portion 14 of the pet vest 12. Specifically, in the illustrated embodiment, each of the first fastening members 32a is secured to a first elastic strap 60, each of which are fixed to a first lateral side 62 of the upper portion 14 of the pet vest 12. The first fastening members 32a are detachably connectable with corresponding second fastening members 32b of the underside portion 16. In this manner, the pet vest 12 is secured to the pet 10. The connection between the first and second fastening members 32a and 32b will be further discussed in this disclosure below.

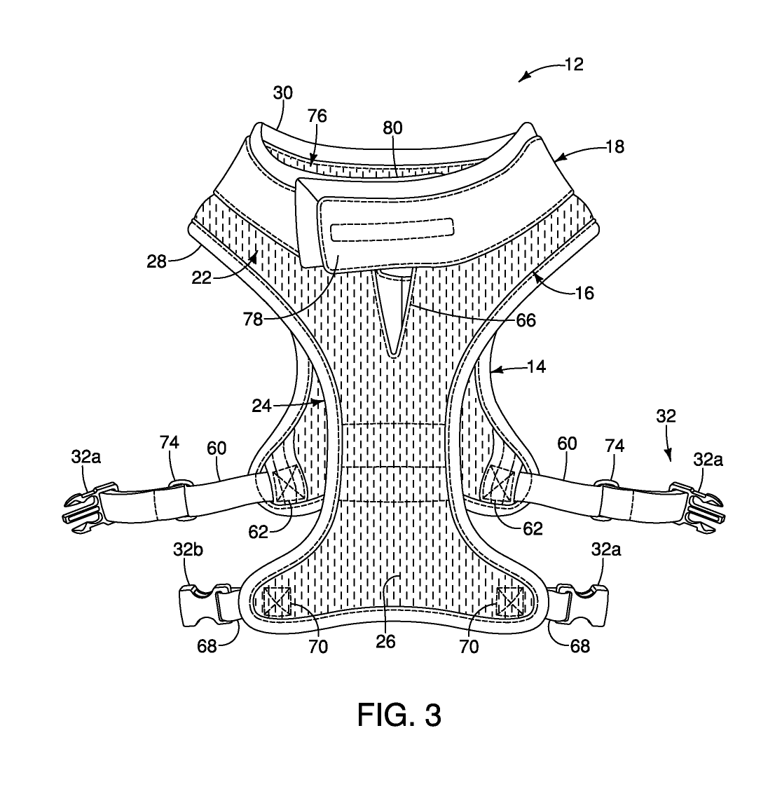

The underside portion 16 of the pet vest 12 will now be discussed. The underside portion 16 is sized and structured to cover a pet 10 ventral area 64. As best seen in FIGS. 1 and 2, in the illustrated embodiment, the underside portion 16 overlies a pet chest area 64a when the pet vest 12 is worn by the pet 10. Thus, in the illustrated embodiment, the pet ventral area 64 includes the pet chest area 64a and the pet stomach area 64b. Preferably, at least a part of the underside portion 16 is padded to minimize bunching or folding of the pet vest 12 during pet wear. In the illustrated embodiment, the underside portion 16 is sewn to the upper portion 14 and the collar portion 18 at the connected sections 20. It will be apparent to those skilled in the art that the underside portion 16 can be attached to the upper portion 14 and the collar portion 18 by other techniques such as by adhesive or stitching as needed and/or desired. Preferably, the attachment techniques will result in a permanent or fixed attachment between the upper portion 14, the underside portion 16 and the collar portion 18.

As shown in FIGS. 2, 3 and 6, the underside portion 16 is disposed below the collar portion 18 when the pet vest 12 is worn by the pet 10. The underside portion 16 includes a V-shaped notch 66 disposed adjacent to the collar portion 18. The V-shaped notch 66 is preferably disposed over at least a portion of the pet's 10 chest area 64a beneath the neck area 34b. The arrangement of the V-shaped notch 66 allows the underside portion 16 of the pet vest 12 to remain flat on the pet's ventral area 64 while remaining snug without bunching. The location of the V-shaped notch 66 also helps maintain the proper spatial relationship of the pet vest 12 with respect to the pet's 10 spine. It will be apparent to those skilled in the art that the size of the V-shaped notch 66 will vary for pet vests of different sizes to accommodate different pets. For example, in some cases for particularly small sized pets, the V-shaped notch 66 can be structured such that a perimeter of the V-shaped notch 66 overlaps in order for the collar portion 18 to be securely fastened to the pet.

The underside portion 16 includes at least one second fastening member 32b. In the illustrated embodiment, the underside portion 16 includes a pair of second fastening members 32b that are disposed at laterally opposite sides of the underside portion 16. Similar to the first fastening members 32a, each of the second fastening members 32b are secured to a second elastic strap 68, each of which are fixed to a second lateral side 70 of the underside portion 16. Each of the pair of second fastening members 32b are identical and are configured to detachably connect with corresponding ones of the first fastening members 32a. Thus, the first and second fastening members 32a and 32b are detachably connectable to one another.

The connection between the first and second fastening members 32a and 32b will now be discussed. In the illustrated embodiment, each of the pair of first fastening members 32a are identical and each of the pair of second fastening members 32b are identical. For simplicity, the description herein will refer to the connection of one of the first fastening members 32a and one of the second fastening members 32b. In the illustrated embodiment, the first fastening member 32a and the second fastening member 32b are designed to be detachably connectable as a plastic snap-together buckle. Also, in the illustrated embodiment, the first fastening member 32a is configured as a catch end of the buckle. The second fastening member 32b is configured as a hook end of the buckle. The first fastening member 32a receives the second fastening member 32b in a snap-in fit manner. It will be apparent to those skilled in the art from this disclosure that the first fastening member 32a can also be configured as the hook end and the second fastening member 32b can be configured as the catch end of the buckle. As previously stated, the first and second fastening members 32a and 32b are detachably connectable as a snap-in fit buckle. It will be apparent to those skilled in the art from this disclosure that the first and second fastening members 32a and 32b can be secured by a variety of other attachment means, such as buttons, hook and loop fasteners and the like.

As previously mentioned, the first fastening member 32a is secured to the first elastic strap 60 and the second fastening member 32b is secured to the second elastic strap 68. In the illustrated embodiment, the first elastic strap 60 includes an adjustment member 74 configured to enable adjustment of a length of the first elastic strap 60. Thus, an attachment of the first and second fastening members 32a and 32b to each other is adjustable. It will be apparent to those skilled in the art from this disclosure that the second elastic strap 68 can be configured to include the adjustment member 74 as well.

The collar portion 18 of the pet vest 12 will now be discussed. As best seen in FIGS. 6 and 7, the collar portion 18 is disposed between the upper portion 14 and the underside portion 16. As previously mentioned, the collar portion 18 connects the upper and lower portions of the pet vest 12 together such that the pet vest 12 is a one-piece member. Preferably, at least a part of the collar portion 18 is padded for comfortable pet wear and to help prevent bunching and folding of the collar portion 18 during wear.

The collar portion 18 defines a receiving hole 76 sized and structured to substantially cover the pet neck area 34b. In the illustrated embodiment, the receiving hole 76 of the collar portion 18 is defined by a pair of oppositely extending flaps 78 and 80 having ends that overlap with one another. The first and second flaps 78 and 80 are configured to overlap one another and are releasably secured to each other by a fastening structure, such as hook and loop fasteners, snaps or buttons. In the illustrated embodiment as shown, the first and second flaps 78 and 80 are secured to each other by hook and loop fasteners. However, it will be apparent to those skilled in the art from this disclosure that the first and second flaps 78 and 80 can be secured to each other by the other fastening structures mentioned above. The first and second flaps 78 and 80 are configured to overlap at varying degrees to accommodate pets of different sizes. In this manner, the collar portion 18 is configured such that a size of the receiving hole 76 is adjustable.

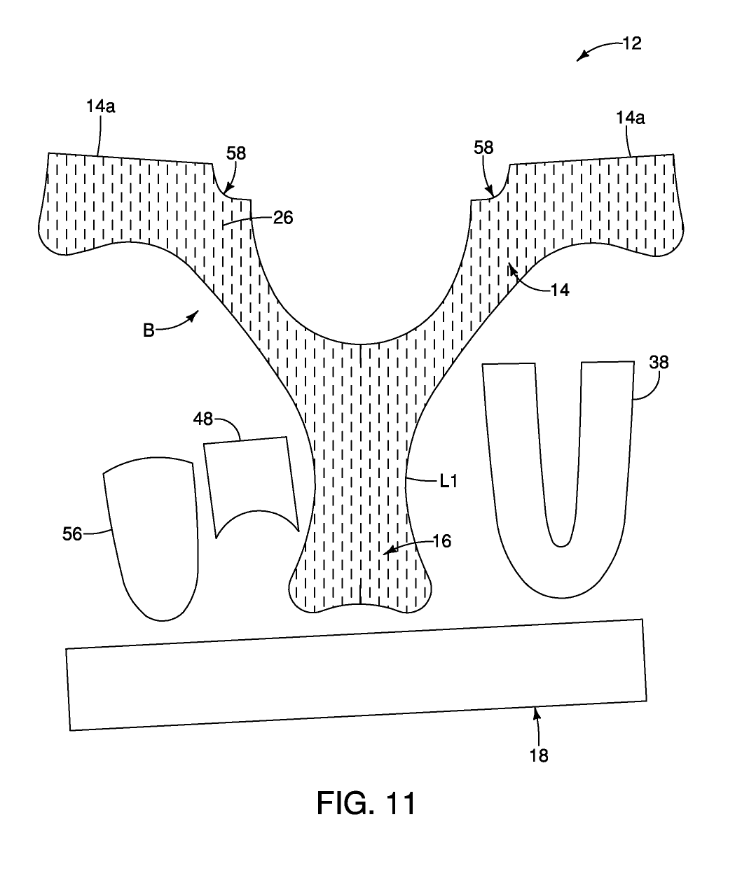

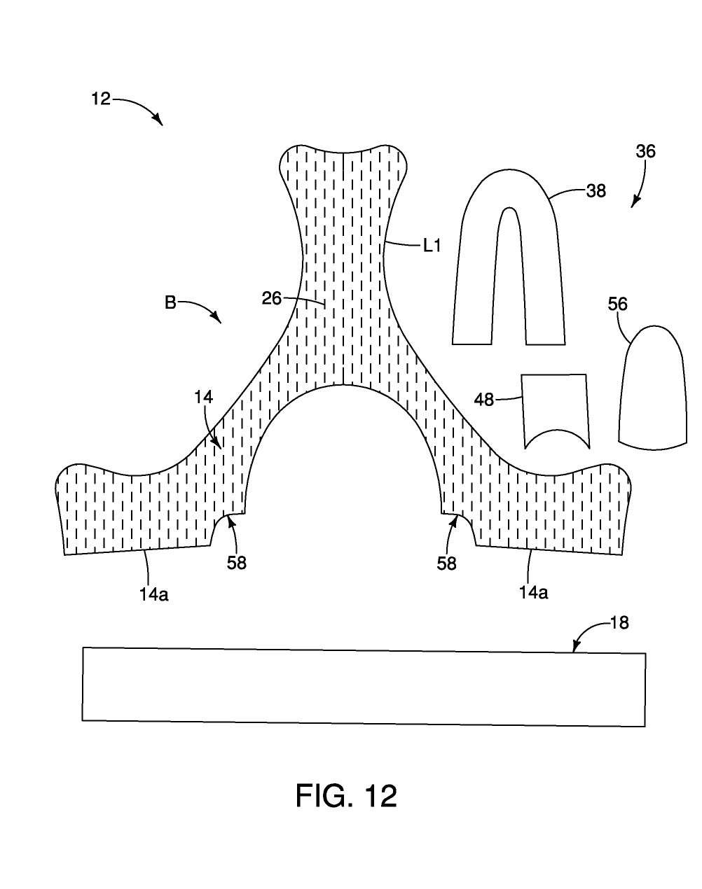

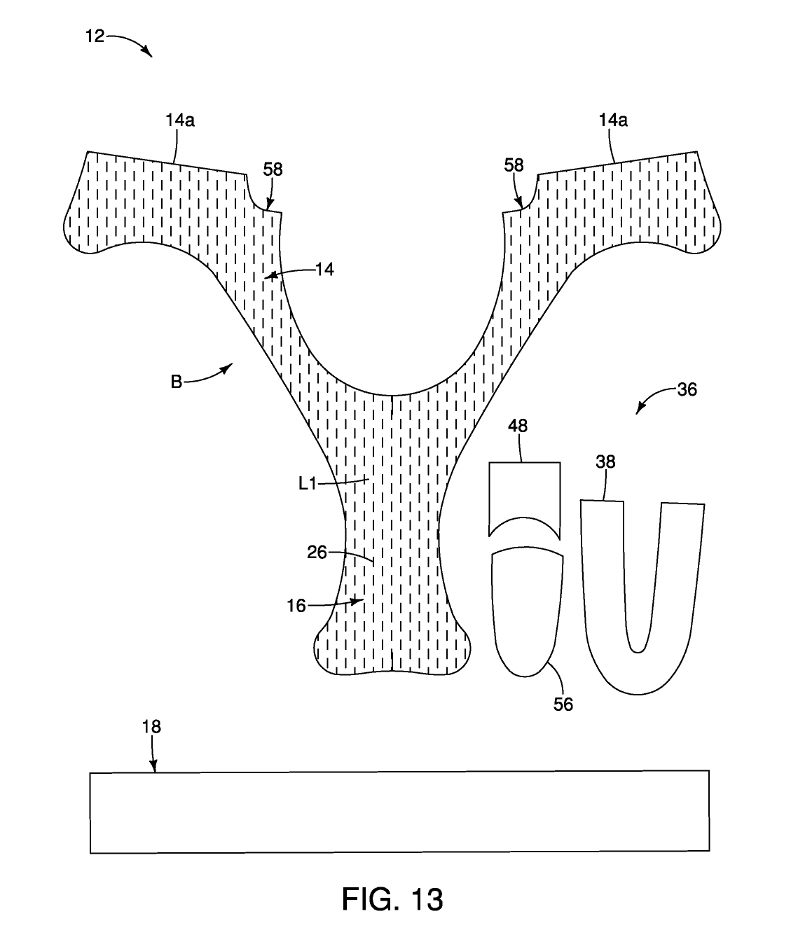

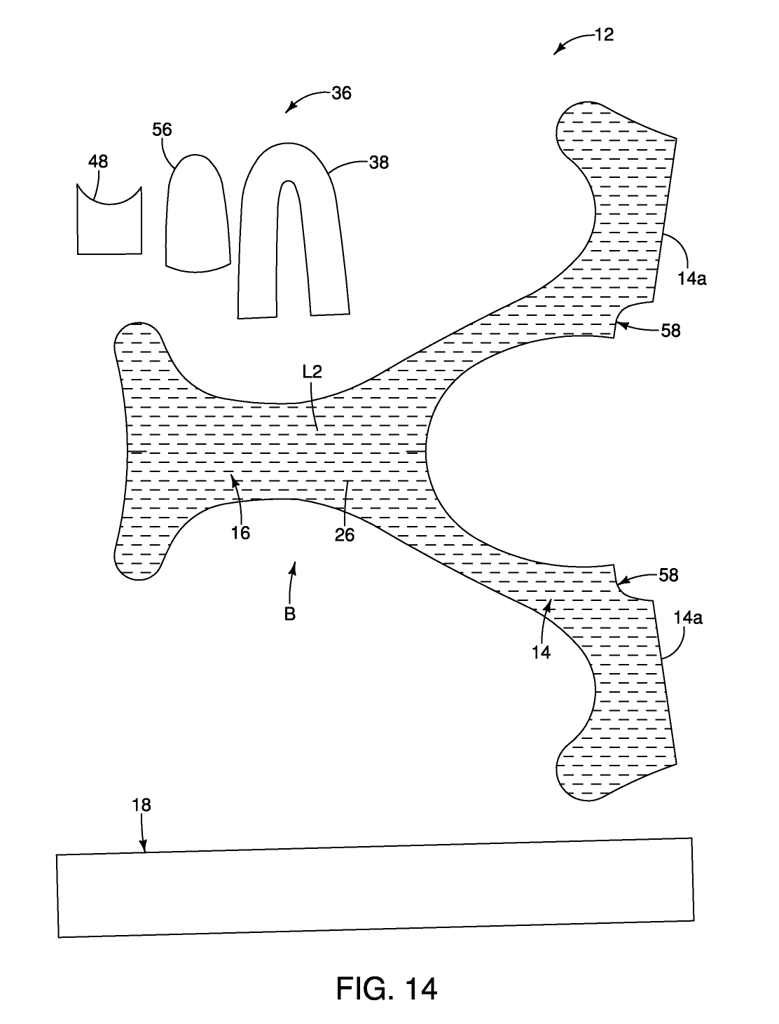

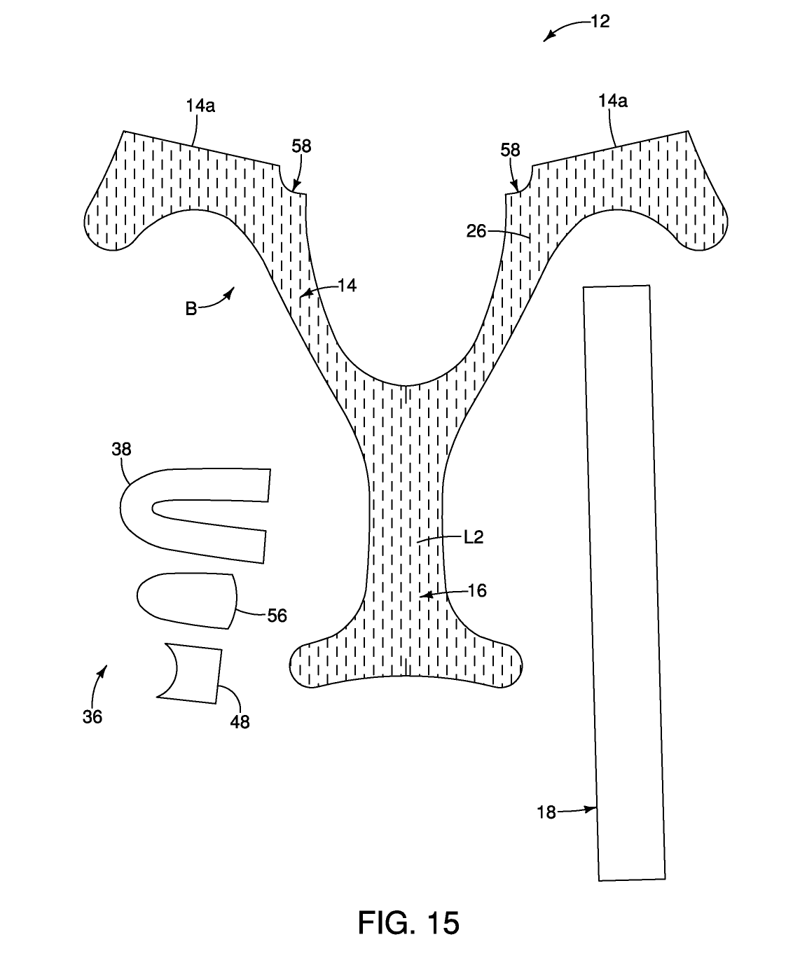

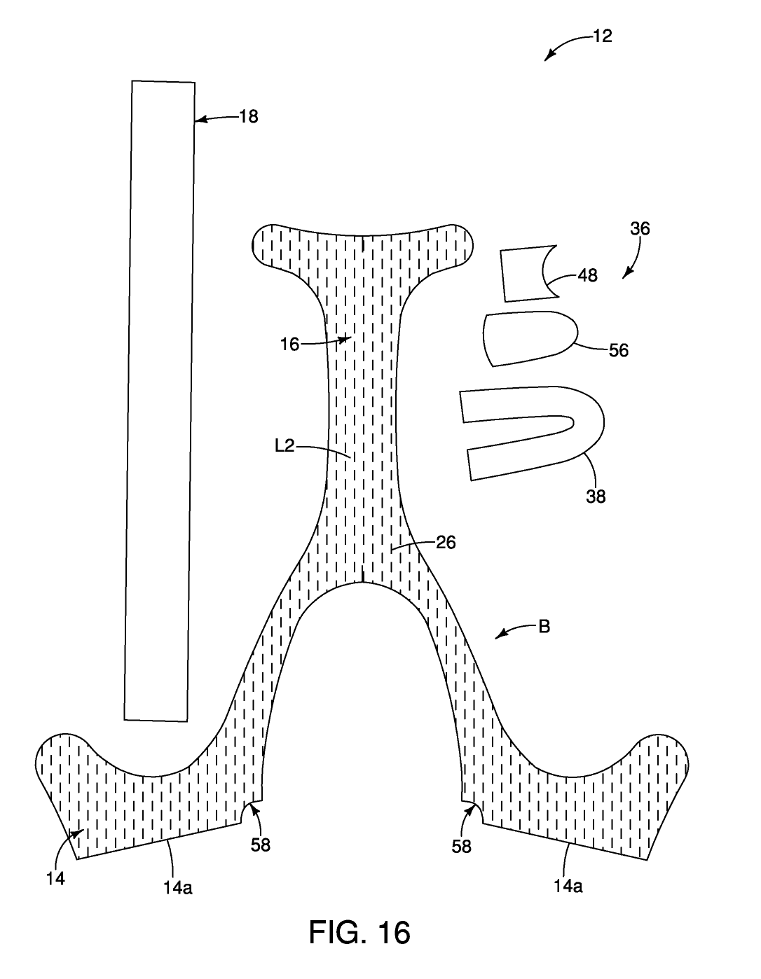

Turning now to FIGS. 11 through 16, the pet vest 12 may be constructed from a variety of patterns to be suitable for pets of varying sizes. In the patterns of the illustrated embodiment, the upper and underside portions 14 and 16 of the pet vest 12 are depicted as a one-piece member that is the main body B of the pet vest 12. The upper portion includes ends 14a that are to be sewn together. In the illustrated embodiment, patterns depicted in FIGS. 11 through 13 can be used for pet vests that are constructed for smaller-sized pets. For smaller-sized pets, the underside portions 16 of these pet vests each have a first length L1. Alternatively, patterns depicted in FIGS. 14 to 16 are examples of patterns for pet vests constructed for larger pets. In this manner, the underside portions 146 of these pet vests 12 each have a second length L2 that is elongated with respect to the first length L1.

In understanding the scope of the present invention, the term “comprising” and its derivatives, as used herein, are intended to be open ended terms that specify the presence of the stated features, elements, components, groups, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts unless otherwise stated.

As used herein, the following directional terms “front”, “rear”, “up”, “down”, “above”, “below”, “upward”, “downward”, “top”, “bottom”, “side”, “vertical”, “horizontal”, “perpendicular” and “transverse” as well as any other similar directional terms refer to those directions of a pet in an upright position and wearing the pet vest. Accordingly, these directional terms, as utilized to describe the pet vest should be interpreted relative to a pet in an upright position on a horizontal surface and that is wearing the pet vest. The terms “left” and “right” are used to indicate the “right” when referencing from the right side as viewed from the rear of the pet, and the “left” when referencing from the left side as viewed from the rear of the pet.

Also it will be understood that although the terms “first” and “second” may be used herein to describe various components these components should not be limited by these terms. These terms are only used to distinguish one component from another. Thus, for example, a first component discussed above could be termed a second component and vice-a-versa without departing from the teachings of the present invention. The term “attached” or “attaching”, as used herein, encompasses configurations in which an element is directly secured to another element by affixing the element directly to the other element; configurations in which the element is indirectly secured to the other element by affixing the element to the intermediate member(s) which in turn are affixed to the other element; and configurations in which one element is integral with another element, i.e. one element is essentially part of the other element. This definition also applies to words of similar meaning, for example, “joined”, “connected”, “coupled”, “mounted”, “bonded”, “fixed” and their derivatives. Finally, terms of degree such as “substantially”, “about” and “approximately” as used herein mean an amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, unless specifically stated otherwise, the size, shape, location or orientation of the various components can be changed as needed and/or desired so long as the changes do not substantially affect their intended function. Unless specifically stated otherwise, components that are shown directly connected or contacting each other can have intermediate structures disposed between them so long as the changes do not substantially affect their intended function. The functions of one element can be performed by two, and vice versa unless specifically stated otherwise. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

1. A pet vest comprising:
an upper portion configured to be disposed on a first area of a pet, the upper portion having a pocket configured to receive a calming device;
a lower portion configured to be disposed on a second area of the pet, and to detachably connect to the upper portion; and
a collar portion disposed between the upper portion and the lower portion and connecting the upper portion to the lower portion, the collar portion defining an opening configured to receive the neck of the pet.

2. The pet vest according to claim 1, wherein
the pocket is configured to be positioned over at least one of the neck of the pet and a pet back area when the pet vest is worn by the pet.

3. The pet vest according to claim 1, wherein
a distal end of the upper portion is detachably connectable to a distal end of the lower portion.

4. The pet vest according to claim 3, wherein
the upper portion includes at least one first fastening member and the lower portion includes at least one second fastening member, the first and second fastening members being detachably connectable to one another to detachably connect the distal ends of the upper portion and the lower portion.

5. The pet vest according to claim 4, wherein
the upper portion includes a pair of first fastening members and the lower portion includes a pair of second fastening members, the first and second fastening members being detachably connectable to one another.

6. The pet vest according to claim 5, wherein
the first fastening members are disposed at laterally opposite sides of the upper portion and the second fastening members are disposed at laterally opposite sides of the lower portion.

7. The pet vest according to claim 4, wherein
an attachment of the first and second fastening members to each other is adjustable.

8. The pet vest according to claim 1, wherein
the collar portion is configured such that a size of the opening is adjustable.

9. The pet vest according to claim 8, wherein
the lower portion includes a V-shaped notch disposed adjacent the collar portion.

10. The pet vest according to claim 8, wherein
the opening of the collar portion is defined by a pair of oppositely extending flaps having ends capable of overlapping with one another and being secured by a fastening device disposed on the pair of flaps.

11. The pet vest according to claim 1, wherein
the pocket includes a transparent window disposed on an outside region of the pocket.

12. (canceled)

13. The pet vest according to claim 1, wherein
the upper portion includes a calming device protrusion opening that is sized and structured to receive a portion of a calming device therethrough to enable direct contact of a pet with the calming device.

14. The pet vest is according to claim 13, wherein
the calming device protrusion opening enables direct contact of at least one of the neck of the pet and a pet back area when the pet vest is worn by the pet.

15-17. (canceled)

18. The pet vest according to claim 1, wherein
at least a part of the lower portion is padded.

19. The pet vest according to claim 18, wherein
at least a part of the upper portion is padded.

20. The pet vest according to claim 1, wherein
at least a part of the collar portion is padded.

21. The pet vest according to claim 1, further comprising
the calming device.

22. The pet vest according to claim 21, wherein
the calming device is configured to vibrate so as to transmit vibration to the pet.

23. The pet vest according to claim 21, wherein
the calming device is configured to deliver a plurality of degrees of vibration.

24. The pet vest according to claim 21, wherein
the calming device is configured to emit at least one of modulated tones and a predetermined aroma.
